(19) United States
(12) Patent Application Publication
(10) Pub. No.: US 2003/0074563 A1
(43) Pub. Date: Apr. 17, 2003

(54) Method for the secure distribution and use of electronic media

(76) Inventor: Simon Alan Spacey, London (GB)

Correspondence Address: SIMON ALAN SPACEY, SUITE 94, 2 LANSDOWNE ROW, LONDON, WIJ GHL, GB

(21) Appl. No.: 10/099,817

(22) Filed: Mar. 18, 2002

(30) Foreign Application Priority Data
Oct. 15, 2001 (GB) 0124700.6

(51) Int. Cl. H04L 9/00

(52) U.S. Cl. 713/181

(57) ABSTRACT

This invention presents a method or system for the secure distribution and use of electronic media. The method can be used to enforce a distributor's license and copyrights with any form of electronic media including music, software and books but is particularly suited to large media formats such as digital movies. The invention as presented can also be used to ensure that distributed files are not tampered with and are secure to give users peace of mind against viruses, trojans and the like.

### BACKGROUND OF THE INVENTION

Piracy has plagued the creative industries since their beginning. The software, book, music and film industries loose billions of dollars each year through illegal copying and distribution of their works. Copyright law is aimed to protect these industries, but with the advent of electronic distribution, the Internet and home CD-RW and DVD-RAM machines, copying has become more insidious and all pervasive than ever before. In the past, piracy was a capital-intensive process, requiring weeks of preparation in a dedicated piracy studio, today piracy is built into every home and the job of enforcing license and copyright law has become increasingly difficult.

The present invention seeks to reduce the impact of media piracy on the creative industries. It does this by introducing a new method of electronic media use and distribution that takes advantage of the growing availability of access to communication networks such as the Internet. The method as presented is suitable for use with any size of media and is not effected by slow network connections such as those typical found in a dial-up to the Internet.

### BRIEF SUMMARY OF THE INVENTION

It is an object of the present invention to provide a method for the secure distribution and use of electronic media that reduces the risk of piracy. The system as presented works with all electronic media formats including music and film and can even be used with instantiable, file-based, electronic media such as software where parts of the media must remain in memory and are accessed at random.

It is a second object of the invention to provide a method to safeguard against viruses, security breaches and unauthorised tampering of installed media.

These and other objects, advantages and features of the present invention are provided by a new method for the delivery and use of the electronic media comprising at least 3 logical stages:

1. Parts of the media are distributed for a client in a disabled form.

2. A media enabling mechanism is provided to the client through a communications network.

3. A Client Instantiation Component (CIC) instantiates or otherwise enables the use of the media parts.

In a method according to the invention, parts of the media are distributed for the client in a disabled form. The disabled parts are constructed in such a way that they can not be used to full effect as distributed and so any copying by pirates is of little commercial consequence. An example of such a disabling mechanism for films would be to distribute the film without the audio track or perhaps only the low frequency (low quality) part of an mpeg video track. For software and other media types, only parts of the media such as data files and/or large library files may need to be distributed to render the distribution “disabled”, the enabling mechanism being to provide the missing parts. In the preferred embodiment, the media is distributed in an encrypted format to clients and the enabling mechanism is the delivery of the decryption key—having the advantage of reducing the network bandwidth required to enable the media.

The disabled media parts distributed in stage 1 can be distributed to clients through a network such as the Internet or with a traditional physical installation (e.g. from a CD) or in any other method as required (e.g. a networked file share). In the preferred embodiment, the disabled media is distributed once to a client in the form of an installation. This differs from a wholly ‘thin client’ approach to media distribution where the media may be supplied to the client each time it is used. Where the disabled media is distributed over a network, the media may be disabled in a different form for different client installations. For example, where encryption is used to disable the media, it is possible to use a different key for different clients and this may help identify the initial source of any license breaches and so be an additional deterrent to would-be pirates.

In a second method according to the invention, a media enabling mechanism is provided to the client. In the preferred embodiment the enabling mechanism is securely provided to a special secured component on the client machine through a network. Having the enabling mechanism provided through a communications network differs from previous media protection systems in that it is not possible for software pirates to, for example, enable locally disabled files by simply disassembling them and removing any software based password or license key protection therein.

In a third method according to the invention, a Client Instantiation Component (CIC) instantiates or otherwise enables the uses of the media parts. In the preferred embodiment the CIC is a secured component that, with the enabling mechanism, enables parts of the locally accessible disabled media in volatile private memory and uses the enabled media from there. In this preferred embodiment then, the enabled version of the media is never directly accessible to pirates in a copyable form as it is not stored in a local file on the machine and, preferably at least, is accessible only to secured components on the client machine.

In a method according to the invention secured components are used. Preferably the components used to: obtain the enabling mechanism, instantiate the enabled media, use the enabled media and ideally the disabled media itself would all be secured. These components can be secured in a variety of ways to ensure that they are not tampered with by pirates. Example securing mechanisms include:

1. Checking components ate valid prior to the delivery of the enabling mechanism with a hash or other function. This may require the delivery of a fresh secured hash routine to the client at the beginning of the enabling process. The routine would generate a hash code for the list of client files that should be secured (including the distributed disabled media itself if required). The hash result would then be validated before a networked machine would provide the enabling mechanism.

2. Delivering and using fresh secure components at each enabling.

3. The use of private and public key certificates to sign the components.

4. Using hardware or ROM implementations of the secured components.

Ideally, the components delivered to the client in the above securing mechanisms (including the hash function of mechanism 1) would be secure. A method for achieving this would be to include in them an integrated random identification number that the securing mechanism would be required to return with any authentication information (hash codes, connect or log-in) to a networked machine within a time limit. This would ensure that the checking and newly secured components delivered as part of the securing mechanism would themselves be validated before the actual enabling mechanism is delivered and it would be difficult for a pirate to create substitute components to unlawfully obtain the enabling mechanism (requiring as it would: the automated request of these securing mechanism components, their de-compilation, the derivation and return of the integrated identification number from the de-compiled code along with any crafted authentication information—all within a time limit). Another method for the securing mechanism components to be validated is through a trusted connection to the client for example an with encrypted channel, a certificate or an established TCP/IP connection.

In an embodiment of the invention, the enabling mechanism is only supplied to secured and authenticated clients. The securing requiring validation of client components with a securing mechanism and the authentication requiring information be passed from the client such as a valid username, password, client IP address, certificates, keys or other information. By logging this validation information license restrictions can be enforced and data mining methods used to identify potential pirates as they attempt to crack the system.

In the preferred embodiment of the invention the enabling mechanism is transferred to a client over a secure network connection. The Secure Socket Layer transport protocol is suggested for this purpose although it is recognised that other methods of securing network communications are possible depending on the implementation and may include the use of private networks.

In a method according to the invention the enabled media is used. This may be either directly by a function of the CIC or by a separate (preferably secured) component accessible by the client machine. In the case of films and music it is easy to see that, once the enabling mechanism has been obtained, functions can be added to the CIC to ‘show’ the media directly as it enables each frame without the use of any extra components. Alternatively, a separate media display mechanism may be required on a client, the CIC perhaps then acting as a streaming server locally installed returning parts of the enabled media as they are needed by that display component or as a secured virtual file store only allowing access to the enabled media by a limited set of (preferably secured) applications. In the case of software, the CIC may simply pass program control to the starting point of the enabled software program in its own process memory space after a memory copy of the enabled media has be created.

In another embodiment of the system according to the invention distributed media is disabled by a combination of the methods discussed including missing parts and encryption. In an embodiment of the invention, the CIC incorporates the functionality of stage 2 of the process of the method described and obtains the enabling mechanism itself from a networked machine through a communication medium removing the need for an extra component for this retrieval purpose.

### BRIEF DESCRIPTION OF THE DRAWINGS

Embodiments of the invention will now be disclosed, for illustration purposes only and without limitation, with reference to the accompanying drawings, in which:

FIG. 1 shows the network architecture of the preferred embodiment.

FIG. 2 shows the deployment architecture of the components in the preferred embodiment.

FIG. 3 shows the outline client process in accordance with an embodiment of the invention.

FIG. 4 shows an alternate deployment architecture of the components according to the invention.

### DETAILED DESCRIPTION

A preferred embodiment of the invention will now be disclosed, without the intention of a limitation, in a computer system for the purpose of using electronic media. For illustration purposes, the media securely distributed and used will be a Java software application but the embodiment as presented can easily be adapted to any other electronic media type. Java is a powerful programming language but many professional commercial programmers have shied away from using it because it is too easy to de-compile and recover the Java source code from distributable Java byte-code classes and programs. This ease of de-compilation means that the secrets of commercial software products can be obtained and that licensing measures embedded into software are easily circumvented if that software is written in Java. By using the invention as disclosed in this embodiment the Java software class files are never stored in an enabled copyable format on the user's machine and thus can not be read as files by a Java de-compilation program but can still be used without functional limitation within license restrictions

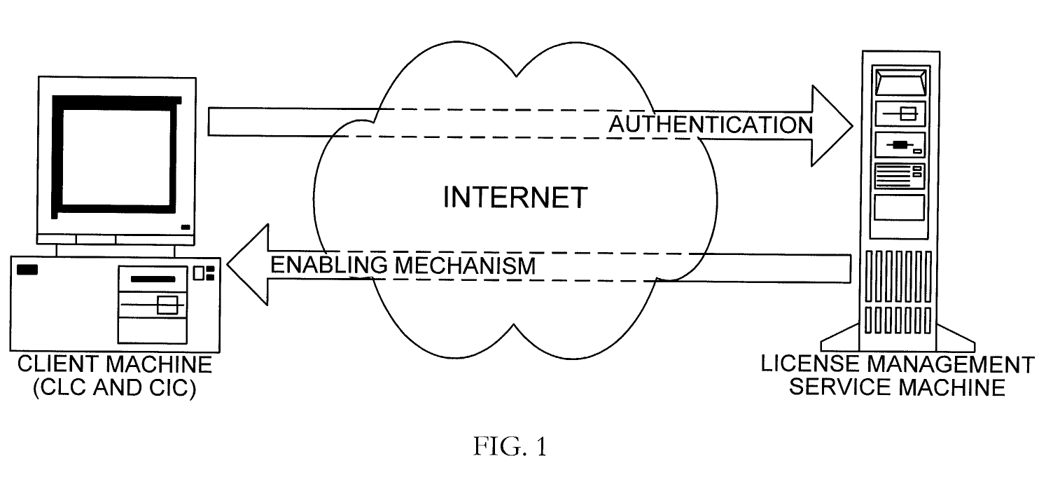

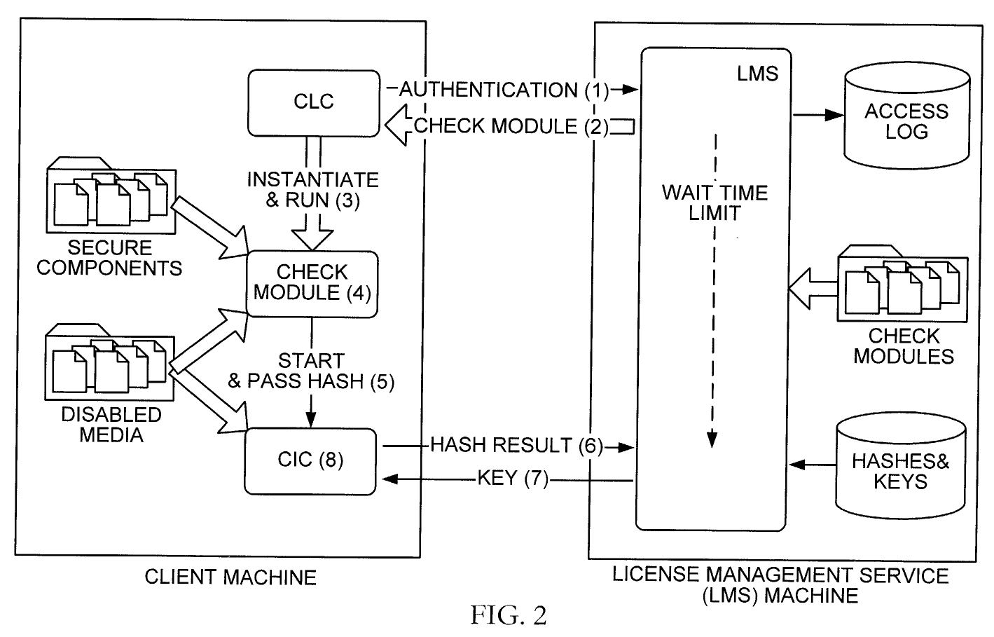

FIGS. 1 and 2 show the architecture of the preferred embodiment. Before the Java application can be run several components are installed on the client machine in this embodiment as depicted with reference to FIG. 2. These include:

1. A Client Log-in Component (CLC). The CLC is executed by the user when they want to start the Java software application and starts the enabling request process. In the preferred embodiment, the CLC initially displays a log-in box for users to provide password and username authentication information which it then passes to a Licence Management Service (LMS) machine through a (preferably secure) communications channel. After contacting the LMS with a valid username and password as initial authentication, the CLC is returned a Check Module which it must run to confirm that the components on the client machine are secure before the LMS will supply the enabling mechanism. The CLC component can be implemented in a standard native executable or of other form as required.

2. A clean Java execution environment. Since the media in this case is a Java software application, a possible route for pirates to obtain a copy of the enabled media would be to create their own modified Java Virtual Machine which would be asked to run/use the enabled media. This option is removed by enforcing the installation of a known execution environment with known hash codes. The environment can be accessed through a path variable or by a defined installation point as required.

3. The disabled Java software application class (media) files. In the preferred embodiment, the classes that make-up the software application media are disabled by encryption. For illustration purposes, the class files could be encrypted with a private key algorithm such as 3DES or RC4 before they are provided to the client machine. It should be recognised that the encryption algorithm is implementation dependent and any public or private key encryption method could be used to disable the media as could removing selected classes from the distribution.

4. A Client Instantiation Component (CIC). The CIC is responsible for enabling the use of the media. In the embodiment as presented for Java applications, the CIC is started by the Check Module as a secure Java class loader in an independent Virtual Machine (VM) specifically started so that it is NOT in debug mode. The CIC is passed the hash code by the Check Module that it (preferably securely) then sends to the LMS for verification. Assuming the hash code is correct, the CIC is returned the key for the disabled/encrypted Java software application class files which it now decrypts and instantiates as a Java software application in its VM.

It is worth noting at this stage that, in this preferred embodiment, the Check Module is not static and is obtained from the LMS each time the user tries to start an instance of the disabled Java software media using the CLC. The CLC is passed a selected Check Module with an integrated random identification number from the LMS which it then instantiates and passes execution control to. In this embodiment as only a single hash result is returned to verify all the client components are secure, the Check Module uses its identification number in the calculation of the hash result (perhaps initialising the hash with the bytes of the identification number or XORing the hash result before returning it). This makes the returned hash result dependant on the Check Module identification number and prevents hackers simply returning a static hash result to the LMS to get the enabling key.

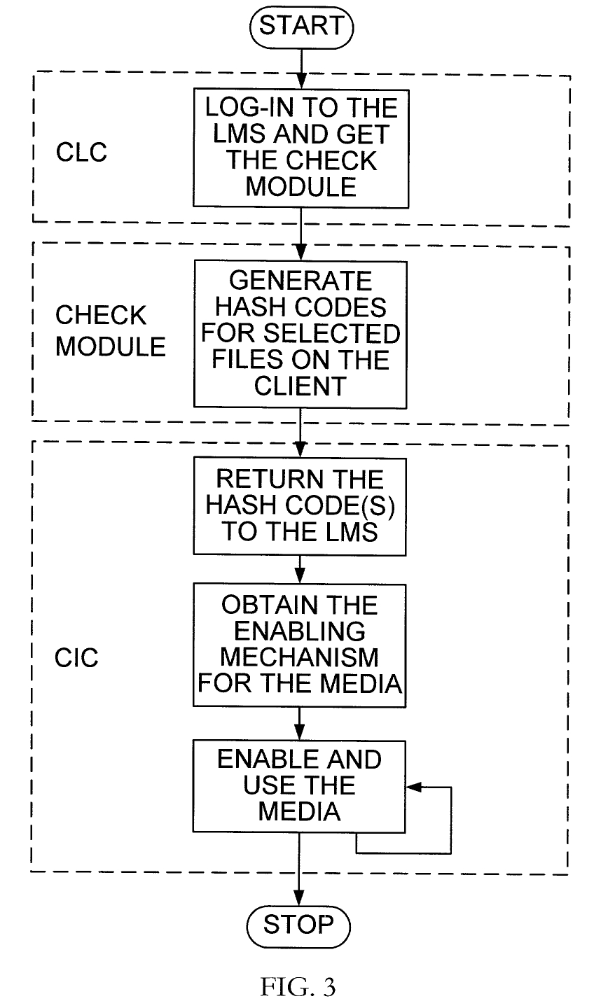

FIG. 3 shows the basic process of starting the disabled Java application media in accordance with this embodiment. The main stages of the process are:

1. The CLC is started and sends authentication information to the LMS over a communications channel. This authentication information can include a username, password and even the client IP address. The LMS checks this authentication information to enforce license and usage restrictions and to start an access log entry and then it returns a selected Check Module to the CLC. Where different disabling mechanisms arc used for different users or media distributions, the authentication may be requited to identify the correct key and/or Check Module for this client. It is assumed that the LMS breaks the connection with the CLC after the selected Check Module is transferred and waits for a hash result to be returned from the client.

2. The CLC receives the Check Module and, in the preferred embodiment, instantiates the Check Module directly in its own process virtual memory and passes control to the start of the Check Module. Alternatively, the Check Module can be transferred as a standard executable (rather than a process routine) and this executable can be stored in a temporary file by the CLC and ran in a separate process as the CLC terminates.

3. It is assumed in this embodiment that the Check Module has an integrated list of files that it must generate hash codes for. This list could be in the form of a top level directory obtained from a client side path variable or a file by file list. In either case it should include at least the CLC, CIC and Java execution environment and preferably the disabled media files as well. The bytes of all the files in the list are hashed together and combined with the Check Module's identification number to summarise the state of the client components. One advantage of a directory based list instead of a file by file list is that extra files in secured directories would effect the hash result.

4. When the Check Module has created its hash of the secured files, it starts the CIC. In the preferred embodiment, it uses the Java Virtual Machine (JVM) it has secured in one of the checked directories to run the CIC (which is a secure Java class loader in this embodiment). The JVM is started with the CIC main class and the calculated hash code as parameters but NOT in debug mode. The CIC starts and sends the passed hash code along with any other required information to the LMS where it is verified.

5. The LMS verifies the hash code against what it would expect given the hashes for the clean secured components and the Check Module's identification information. The LMS may also take note of the time the client has taken to return this hash and, if it is to long or the hash code invalid, it may log the issue in the Access Log for future data mining. Assuming the hash code is accepted from the client, the LMS returns the enabling key to the (now) secured CIC through the communications connection.

6. When the CIC receives the key it opens the main class of the disabled lava software application, decrypts the file with the key, obtains the byte codes, instantiates the class and runs the media (optionally mapping a known interface onto the class). The main class may in turn request other classes from the disabled application with the CIC acting as a secure class loader.

The process above can be generalised in a variety of ways so that multiple disabled media collections (Java software applications here) installed on the same machine, each potentially with a different key, can use a shared CLC and CIC to instantiate them. As a first method, the shared CLC could be started with a parameter indicating which disabled media collection is to be run (perhaps through a parameterised shortcut). It could send this parameter through to the LMS to obtain a Check Module corresponding to that media collection which would start the CIC with the identifier or main class of that collection as a parameter. Secondly, there could be a different username and/or password for each media collection that would be recognised by the LMS and again the selected Check Module could be implemented to pass the correct media path to the CIC. Alternatively, the CIC could be passed the disabled media name with the key from the LMS or through an environment variable or via an IPC from another component like the CLC. And as yet another example, the secured CIC could automatically start a selector application which would list all the disabled media collections installed on the client and allow the user to select the one to run, the key for which could then be obtained form the LMS by the secured (trusted and registered) CIC.

In accordance with this embodiment of the invention, the CIC is provided with the hash code by the Check Module. This could be as a parameter to the JVM execution or equally well be through the Java Native Interface, shared memory or other IPC method.

In accordance with the present invention, the CLC and CIC communicate with the LMS over a communications channel. In the preferred embodiment, this communication is through an encrypted channel. A method suitable for securing these communications over the Internet would be using the Secure Socket Layer (SSL) communications protocol. This may have the advantage that the client could identify itself to the LMS with a public-private key certificate mechanism perhaps removing the need for client log-in and username as initial authentication messages.

In a first embodiment of the invention, a simple license database is used by the LMS to validate users. This database has two purposes. Firstly, it holds the relation between usernames, passwords, keys and applications so that users can be validated and the correct Check Module and key returned. Secondly, it may hold authentication heuristics derived from the users machine and network performance which allows the wait time limit to be different for each client (perhaps by username, hardware ids, installation number or IP address). This second feature may prevent users with fast machines from being given enough time to derive the identification number from the Check Module and return a crafted hash result within a LMS time limit designed to cope with slower machines. The feature may also help the licenser to monitor license breaches such as multiple copies of the same installation being used unlawfully on different machines with the same log-in through a proxy server (same log-in, the same IP address but different physical machines).

In step 1 of the enabling process above, the LMS selects a Check Module for the client. It is preferred that the Check Modules are native components that can be loaded into the CLC process memory and executed directly but they could equally well be separate executable files or even Java classes that must be executed within the time constraints of the LMS. These components can be pre-compiled or compiled as needed by the LMS, but in either case the LMS must know the identification number of the Check Module it selects to send to the CLC.

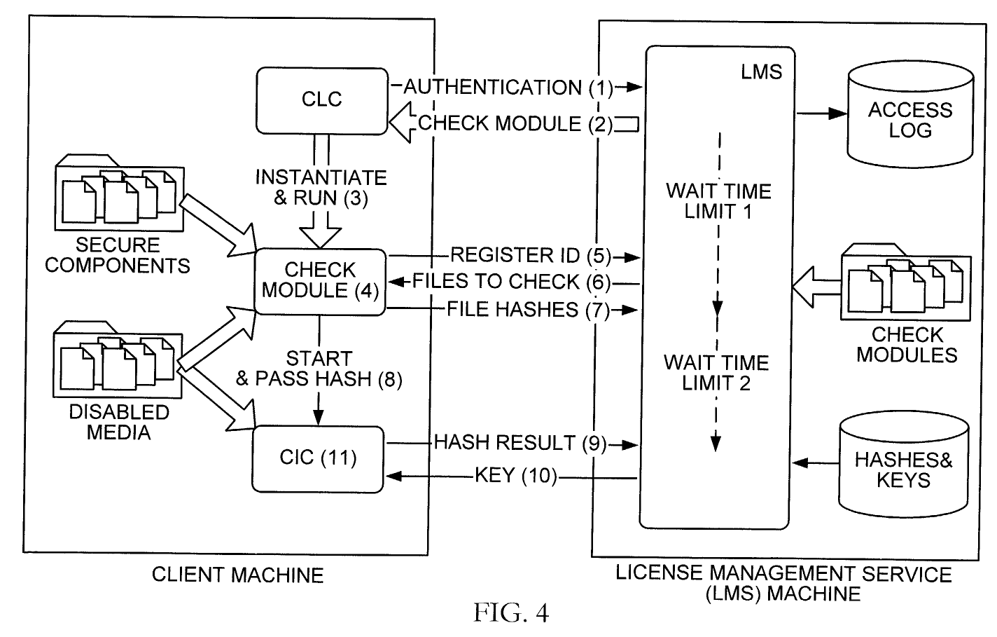

In the preferred embodiment, the Check Module selected can be hard coded with a list of the files, directories or environment paths to check and with the disabled main class to run for a selected media distribution and, as presented so far, it returns only a single hash result. In a second embodiment as illustrated by FIG. 4 however, the Check Module again has a hard coded identification number, but this time it obtains a list of the files, directories or paths it should check for this media distribution from the LMS. The Check Module may then return an individual hash result for each file to the LMS. This embodiment has the advantage that the LMS can more easily spot potential pirates as they try to crack the system a file at a time and may automatically allow corrupt, tampered or old files to be replaced on the client. It is easy to see how the preferred embodiment presented in FIG. 2 can be enhanced to return a list of hashs for each file by simply passing said hash list to the CIC for delivery to the LMS instead of a single hash result.

The Check Module may be optimised to check only some of the files each time, be run only on a determined basis (perhaps randomly) or it may be stored static on a machine for a determined lifetime. This has the advantage that the full component hash may not be required each time a client starts the media and so the media may start quicker in most instances. The Check Module may be further optimised by it not starting the CIC if files are missing or hash results do not match an internal check value. If this were the case, the Check Module could immediately inform the LMS of detailed information about the discrepancy and the user.

In the preferred embodiment, the enabling mechanism is a key and the decryption algorithm is implemented as part of the CIC. The enabling mechanism could equally well be the provision of say a missing sound track or program/class files to the client or a different key could be used for each disabled media file. In the case of a missing sound track, the data could easily be streamed or chunked to the CIC as required by the client to synchronise with a displayed video track.

The enabling mechanism could equally well be the provision of a routine to the CIC instead of just a key. A decryption routine could be provided in the form of a native executable, library or a Java class file to the CIC after it has been secured. The advantage of providing the enabling mechanism as a routine after securing is that the pirates would not be able to identify the algorithm used (e.g. 3DES or RC4) by disassembling the CIC and this would make the task of key guessing even more difficult.

In the preferred embodiment presented, the CLC, Check Module and CIC are different components constructed in a variety of different languages (native executables, native modules and compiled Java classes). The component structure and implementation language is a function of the embodiment and media type and not limited by the invention. It is easy to see that in an embodiment designed to execute disabled native software media, the CIC would be perhaps better implemented in a native module. In any case, the functionality of one or more of the client components could be implemented in a combined component which could even have the disabled media integrated into it as a data or other segment (for example a CIC component file could have the encrypted disabled media in it as a data section instead of having separate disabled media files).

In a modification to the preferred embodiment, components of the distribution may be stored off the client machine perhaps in a group central file store or distributed on an as needed basis over a network as in a thin-client. It is also possible to have some of the elements (for example, disabled film or music media) streamed to the client instead of accessible randomly as in files.

In an embodiment of the invention adapted for movies, the movie file is optionally split into a number of manageable parts (perhaps 5 min long each) and these parts are encrypted with a key. The disabled movie (parts) are then installed on a client machine along with a native CLC and a modified CIC. The CIC used in this embodiment could be a native CIC with movie displaying functionality built-in. The enabling process is the same as in FIG. 3 except that the Check Module would (as a minimum) only have to check the CIC component. In this case, the CIC would use the enabled media by displaying frames of the enabled film and sound track to the user instead of instantiating the enabled media as a Java program. Note that in this embodiment, there may be no additional need for a secured Java execution environment on the client (assuming the CIC is a native executable).

As an alternative to the above, a different CIC implementation could provide a local viewer with access to the enabled media. In this alternative, it would be preferable if the Check Module confirmed also that the viewer and all dependant files were secured before the key were provided to the CIC. The CIC could then act as either a virtual file store or a media streaming server as required by the secured viewer. The approach of the CIC acting as an enabling file store or a server presented here can easily be extended to software, documents and other media formats if required.

Finally, the LMS server may be distributed across multiple machines. This distribution may be by functional separation (authenticate, create check modules, deliver check modules, confirm hashes, deliver keys etc.) or by load separation (username, bandwidth, media size, media type etc.) or other means. An example of a load separation would be to mirror the LMS machine across many parallel machines which would be accessed by different users. An example of a functional separation would be to say have the initial CLC and Check Module delivery on one machine and have the hash conformation and key delivery on another. Additionally, alternate implementations of the LMS may use a key generation algorithm instead of a local hash/key store database (as a database could theoretically be hacked into), and they may provide varying degrees of authentication and access log detail for different media and users.

Those skilled in the art will appreciate that there are numerous potential implementations within the scope of the invention as described. It is recognised that such implementations may use the methods of the invention for other purposes. An example of one such purpose may be to secure local user work, data and application files from unauthorised access—the files being stored in a disabled form and access being granted by the delivery of an enabling mechanism through a network to optionally secured components after authentication.

We claim:

1. a method for the delivery and use of electronic media, characterised by:
a) Parts of the media being distributed for a client in a disabled form.
b) A media enabling mechanism being provided for the client through a communications network.
c) A Client Instantiation Component (CIC) instantiating or otherwise enabling the use of the media parts.

2. A method in accordance with claim 1, wherein selected components on the client machine are optionally secured before the media enabling mechanism is provided to the client.

3. A method in accordance with claim 2, wherein said component securing is performed by one or more of the following securing mechanisms:
a) Calculating a hash function for selected components. Said hash function results ideally being returned to a networked machine for validation.
b) Delivering and using fresh secure components.
c) The use of private and public key certificates to sign the components.
d) Using hardware or ROM implementations of the secured components.

4. A method in accordance with claims 2 and 3, wherein the securing mechanism is itself secured by means of a known identifier, trusted connection or other means and may optionally have to return information to a networked machine or component within a time-limit.

5. A method in accordance with claims 2, 3 or 4 wherein the securing mechanism is a Checking Module distributed to the client from a networked machine over a communications medium.

6. A method in accordance with any of the previous claims wherein components accessible by the client are automatically replaced if they are judged insecure or outdated.

7. A method in accordance with any of the previous claims wherein the disabled media parts are disabled by one or more of the following:
a) Encryption, the enabling mechanism being to deliver a decryption key and optionally a decryption algorithm.
b) Missing parts, the enabling mechanism being to deliver the missing parts.

8. A method in accordance with any of the previous claims wherein the disabled media and other components of the invention are distributed to the client in the form of randomly accessible media files or as streams through:
a) An installation process.
b) A network file store.
c) On an as needed basis through a network as in a thin client.

9. A method in accordance with any of the previous claims wherein the enabling mechanism is provided only after the client has been authenticated by means of a username, password, certificate, key, ip address, machine characteristics or other means.

10. A method in accordance with any of the previous claims wherein one or more of the the network communications is secured through encryption, a private network or other means.

11. A method in accordance with any of the previous claims further characterised by the use of 3 logical components as part of the main client side media enabling process:
a) A Client Log-in Component (CLC) that contacts a networked machine and sends any initial authentication information from the client to that networked machine.
b) A Check Module which is returned from a networked machine in response to valid client authentication information and is run by the client to validate the secured components the client has access to.
c) A Client Instantiation Component (CIC) which allows the use of enabled media. The CIC may optionally return the Check Module results to the networked machine for validation itself and may receive and apply the enabling mechanism to the disabled media directly.

12. A method in accordance with claim 11 wherein the functions of the logical components are implemented in any of:
a) Separate modules.
b) Combined functionality modules or subroutines.
c) Functional modules combined with disabled media parts.

13. A method in accordance with claims 11 or 12 wherein the process of enabling the media is characterised with reference to the figures by:
a) The CLC contacting a networked machine with optional initial authentication information and receiving back a selected Check Module.
b) The Check Module executing and optionally validating components accessible by the client that should be secured in order to ensure the security of the enabling mechanism and the media.
c) The CIC being started in a preferably non-debug secured environmnent and any Check Results being returned to a networked machine (either by the CIC or another mechanism).
d) The CIC obtaining the enabling mechanism for the media from a networked machine.
e) The CIC enabling the use of portions of the media.

14. A method in accordance with claims 11, 12 or 13 wherein said networked machine is a Licence Management Service (LMS) with the following functionality:
a) Authenticates client CLC requests and returns selected Check Modules to the client.
b) Verifies Check Module results with reference to optional Check Module identification information and an optional time limit for the return of verification information.
c) Issues media enabling mechanisms to verified clients.
d) Optionally tracks usage and highlights potential license breaches by using machine and timing heuristics, log-in information and Check Module results.

15. A method in accordance with claim 14 wherein the LMS is distributed either functionally or on a load basis amongst several machines in a communications network or otherwise.

16. A method in accordance with any of the previous claims wherein the media is further defined to include: instantiable random access media such as software, sequential media such as films and music and other media such as books, application files, user work and data.

17. A method in accordance with claim 16 wherein the media includes Java application software.

18. A method in accordance with any of the previous claims wherein the process by which the enabled media is used is itself secure, characterised by one or more of:
a) Instantiating enabled software media either in the process space of the CIC or in a separate process space.
b) Providing enabled media parts to a, preferably secured, viewing application on a stream or a secured virtual file system basis.
c) The CIC using the enabled media.

19. A method in accordance with any of the previous claims wherein a different key or disabling mechanism is used for different media collections, files, users, clients or other units.

20. A method in accordance with any of the previous claims wherein the use of more than one disabled media collection is enabled by using shared enabling components such as shared CLC and CIC components.

21. A method substantially as herein described with reference to FIGS. 1 to 4 of the accompanying drawings.

22. Apparatus configured to perform any of the methods of the previous claims.

23. Use of any of the previous methods of claims.
